(19) United States
(12) Patent Application Publication
(10) Pub. No.: US 2024/0327215 A1
(43) Pub. Date: Oct. 3, 2024

(54) PARTIAL OXIDATION REACTOR AND PROCESS FOR PRODUCING A RAW SYNTHESIS GAS STREAM

(71) Applicant: L'Air Liquide, Société Anonyme pour l'Etude et l'Exploitation des Procédés Georges Claude, Paris (FR)

(72) Inventors: Karsten COVELLA, Frankfurt (DE); Hongbin XU, Frankfurt am Main (DE); Matthias MUELLER-HAGEDORN, Frankfurt am Main (DE)

(73) Assignee: L'Air Liquide, Société Anonyme pour l'Etude et l'Exploitation des Procédés Georges Claude, Paris (FR)

(21) Appl. No.: 18/620,531

(22) Filed: Mar. 28, 2024

(30) Foreign Application Priority Data
Mar. 30, 2023 (EP) 23165316.3

(51) Int. Cl. C01B 3/36; B01J 19/00; B01J 19/02; B01J 19/24

(52) U.S. Cl. CPC C01B 3/363; B01J 19/0013; B01J 19/02; B01J 19/24; B01J 2219/00157; B01J 2219/0263; B01J 2219/1943; B01J 2219/1946; C01B 2203/0255; C01B 2203/0816; C01B 2203/1241; C01B 2203/148

(57) ABSTRACT

The invention relates to a partial oxidation reactor (POX reactor) for producing a raw synthesis gas stream by partial oxidation of a carbon-containing input stream in gaseous form, in liquid form or in solid, particulate form dispersed in a carrier liquid or a carrier gas in the presence of an oxygen-containing oxidant stream and optionally a moderator stream containing steam and/or carbon dioxide. The invention further relates to a process for producing a raw synthesis gas stream. The partial oxidation reactor according to the invention provides for introducing a cylindrical or frustoconical inlet region having a constant diameter or a diameter that is smaller on the entrance side. The inlet region is arranged upstream of a cylindrical main reactor portion and represents a bottleneck-like section since the largest diameter of the inlet region is smaller than the diameter of the cylindrical main reactor portion.

### CROSS REFERENCE TO RELATED APPLICATIONS

This application claims the benefit of priority under 35 U.S.C. § 119 (a) and (b) to European Patent Application No. 23165316.3, filed Mar. 30, 2023, the entire contents of which are incorporated herein by reference.

### BACKGROUND

### Field of the Invention

The invention relates to a partial oxidation reactor (POX reactor) for producing a raw synthesis gas stream by partial oxidation of a carbon-containing input stream in gaseous form, in liquid form or in solid, particulate form dispersed in a carrier liquid or a carrier gas in the presence of an oxygen-containing oxidant stream and optionally a moderator stream containing steam and/or carbon dioxide. The invention further relates to a process for producing a raw synthesis gas stream.

### Prior Art

Synthesis gases are gas mixtures containing hydrogen and carbon oxides which are used in various synthesis reactions. Examples thereof are methanol synthesis, the production of ammonia by the Haber-Bosch process or Fischer-Tropsch synthesis.

A commonly used process for producing synthesis gases is autothermal entrained flow gasification of gaseous, liquid or solid fuels, as described for example in DE 10 2006 059 149 B4. At the top of a reactor an ignition and pilot burner is arranged centrally and three gasification burners are arranged with rotational symmetry to the reactor axis. Via the gasification burners coal dust with oxygen and steam as gasification agents is supplied to a gasification space of the reactor in which the fuel is converted into synthesis gas. The hot gasification gas exits the gasification space together with the liquid slag and passes into a quench space into which water is injected for cooling of raw gas and slag. The slag is deposited in the water bath and is removed via a slag outflow. The quenched raw gas is withdrawn from the quench space in a steam-saturated state and purified in subsequent purification stages. Since the fuel is reacted directly with the oxidant, the oxidant and the fuel must be supplied coaxially or coannularly.

U.S. Pat. No. 5,549,877 A1 also describes a process and an apparatus for producing synthesis gas, wherein an oxygen-containing oxidant is supplied centrally at the top of the reactor and, together with fuel supplied annularly around the oxidant feed is introduced into the reaction space where the fuel is initially reacted substoichiometrically. A flame which spreads downwards into the reaction space is formed. In a recirculation zone the materials present in the flame flow back in the upward direction. An additional stream of oxidant is supplied into the reaction zone downstream via an annular conduit, thus forming a more extended flame zone.

The partial oxidation of hydrocarbon-containing input material for producing synthesis gas is typically performed at high reactor temperatures in the range from 1000° C. to 1500° C. and pressures of up to 100 bara. The reactors used for non-catalytic partial oxidation (POX reactors) are often refractory lined reactors with hemispherical or virtually hemispherical domes. The partial oxidation burner (POX burner) is generally mounted at the top of the dome here.

The technical processes and apparatuses for partial oxidation known from the prior art propose various apparatuses for introducing and mixing the various streams, i.e. the hydrocarbon-containing input material, a generally oxygen-containing oxidant and sometimes a moderator. Moderators used are often carbon dioxide (CO₂) or steam, wherein the moderator is separately introduced into the reactor via a separate channel within the burner or admixed with one or more of the other input streams upstream of the burner. The oxidant employed is typically air, enriched air or pure oxygen (comprising at least 95 mol % of oxygen). A hydrocarbon-containing feed stream is a stream containing hydrocarbons such as methane or higher hydrocarbons or other hydrogen- and carbon-containing molecules (for example alcohols such as methanol, ethanol). This may also be a stream derived from an upstream primary reformer and containing not only carbon monoxide (CO), hydrogen (H₂), CO₂ and water (H₂O) but also hydrocarbons such as methane, ethane, ethylene or higher hydrocarbons such as benzene, toluene or xylenes. The mixing of the hydrocarbon-containing input material and the oxidant is generally carried out in a reactor in close proximity to the injection nozzles.

In partial oxidation reactors known from the prior art the reactor geometry results in formation of a recirculation zone which occupies a large volume of the reactor. By contrast, along the central axis of the reactor towards the outlet a jet is formed. This jet is characterized by a high velocity which minimizes the available reaction time of the entrained molecules. This results in a residence time distribution within the reactor which is characterized by a peak at very short residence times and a long run-out through the recirculation zone. However, to achieve high conversions of the input materials a sufficient time for the reaction of the input material is required which has hitherto been realized through a corresponding length of the POX reactor.

It is further disadvantageous that due to the formation of a recirculation zone hot synthesis gas flows back to the entrance-side reactor top side of the POX reactor and to the burner arranged there and it leads there to elevated material attrition, for example through corrosion (e.g. high temperature corrosion) of the outer tubes or channels of the burner in particular. As a protective measure the POX burner is therefore mostly cooled, though this increases the capital and operating costs and harbours risks in case of failure of burner cooling during operation.

These disadvantages are particularly relevant if the production capacity of an existing partial oxidation reactor is to be increased since a higher throughput of the input materials exacerbates the described disadvantages.

### SUMMARY

It is accordingly the object of the present invention to specify a partial oxidation reactor for producing a raw synthesis gas stream which does not exhibit the recited disadvantages of the partial oxidation reactors known from the prior art.

This object is achieved in a first aspect of the invention by a partial oxidation reactor having the features of claim 1 and in a further aspect of the invention by a process for producing a raw synthesis gas stream having the features of claim 10. Further embodiments of the invention are apparent from the subsidiary claims of the respective category.

Fluid or fluidized carbon-containing fuels or carbon-containing input streams include all gases, liquids, slurries, aerosols and pneumatically conveyed solids particles which contain carbon in elemental or chemically bonded form and which experience continuous flow as a consequence of an applied shear stress, an external force or a pressure difference. A non-exclusive list of examples comprises hydrocarbon-containing gases such as natural gas, hydrocarbon-containing liquids such as naphtha, petroleum fractions, liquid refinery residues, solid carbon-containing particles such as coal or coke powder or dusts.

An oxygen-containing oxidant is to be understood as meaning any oxygen-containing fluid, for example pure oxygen in any desired purity, air or any other fluid capable of supplying oxygen to a carbon-containing reactant.

A means is to be understood as meaning an article which makes it possible to achieve, or is helpful in achieving, an objective. Means for performing a particular process step are in particular to be understood as meaning all physical objects which a person skilled in the art would consider for performing this process step. For example, a person skilled in the art will consider means for introducing or discharging a material stream to include all transporting and conveying apparatuses, i.e. for example pipe conduits, pumps, compressors, valves, which seem necessary or sensible to said person skilled in the art for performing this process step on the basis of their knowledge of the art.

In the context of the present description, steam is to be understood as a synonym for water vapour unless the opposite is specified in the individual case. By contrast, the term “water” relates to water in the liquid state in the absence of indications to the contrary in the individual case.

If required, pressures are specified in absolute pressure units, bara or bar (a) for short, or in gauge pressure units, barg or bar (g) for short, in the absence of indications to the contrary in the individual case.

A fluid connection between two regions of the apparatus or plant according to the invention is to be understood as meaning any type of connection which makes it possible for a fluid, for example a gas stream, to be able to flow from the one to the other of the two regions, neglecting interposed regions or components. A direct fluid connection is especially to be understood as meaning any type of connection which makes it possible for a fluid, for example a gas flow, to flow directly from the one to the other of the two regions, with no further regions or components being interposed, with the exception of pure transportation operations and the means required therefor, for example pipe conduits, valves, pumps, compressor, reservoirs. One example would be a pipe conduit leading directly from the one to the other of the two regions.

Optionally or electively means that the subsequently described event or the conditions may occur or may not occur or that a feature may be present or may not be present. The description comprises cases in which the event or the condition occurs and cases in which it does not occur. The description likewise comprises cases in which a feature is present or is not present.

The conditions of non-catalytic partial oxidation are known to a person skilled in the art from the prior art, for example the documents discussed at the outset. These are the physicochemical conditions under which a measurable, preferably an industrially relevant, conversion of fluid or fluidized carbon-containing input streams into synthesis gas products is achieved. These include as important parameters the establishment of a suitable partial oxidation temperature of typically about 1000° C. or above. It is especially characteristic for non-catalytic partial oxidation that no catalyst is present in the partial oxidation reactor.

Necessary adjustments of the conditions of the non-catalytic partial oxidation to the respective operational requirements will be made by a person skilled in the art on the basis of routine experiments. Any specific reaction conditions disclosed may serve here as a guide, but they should not be regarded as limiting in relation to the scope of the invention.

The terms entrance, entrance-side, exit, exit-side relate to the flow direction of the input materials through the partial oxidation reactor.

The adjective domed relates to a configuration of a partial oxidation reactor or parts thereof where the outer wall and/or the inner wall replicates sections of a circular or elliptical arc and comprises a highest point at a maximum distance from the centre of the main reactor portion at which the partial oxidation burner is generally arranged.

The following lengths are used to elucidate the invention:
L1 length of the inlet region
D1 free internal diameter of the inlet region (cylindrical)/entrance-side free internal diameter of the inlet region (frustoconical)
D3 exit-side free internal diameter of the inlet region (frustoconical)
D2 free internal diameter of the main reactor portion
Dh hydraulic diameter of the feed channel for the oxygen-containing oxidant stream

The hydraulic diameter of the feed channel for the oxygen-containing oxidant stream is used because the characteristic diameter of the oxygen stream is relevant for the flame length and thus for the selection of the length L1. When the oxidant stream is introduced into the partial oxidation reactor through the central first feed channel having a circular cross section the hydraulic diameter corresponds to the geometric diameter of this feed channel. When the oxidant stream is introduced into the partial oxidation reactor through one of the annular feed channels the hydraulic diameter corresponds to double the slot width of this feed channel.

The invention is based on the finding that in a partial oxidation reactor the recited disadvantages of the prior art are overcome through the introduction of a cylindrical or frustoconical inlet region having a constant diameter or a diameter that is smaller on the entrance side. The inlet region is arranged upstream of a cylindrical main reactor portion and represents a bottleneck-like section since the largest diameter of the inlet region is smaller than the diameter of the cylindrical main reactor portion. This improved geometric configuration of the partial oxidation reactor according to the invention allows higher synthesis gas production per unit of reactor volume and extends the service life of the partial oxidation reactor and its constituents, in particular the POX burner.

The configuration according to the invention of the partial oxidation reactor especially achieves the following advantages:
minimizing the relative volume of the recirculation zone of the gas flow forming in the main reactor portion, expressed as a volume of the recirculation zone based on the reactor volume, and the total volume at a certain flow rate,
increasing the minimum residence time of the reaction gases in the partial oxidation reactor, thus achieving a higher synthesis gas yield per reactor volume,
preventing the hot reactor gases from reaching the burner, thus extending the service life of the partial oxidation reactor and its constituents, in particular the burner.

The proposed solution for achieving these objectives comprises attaching a neck or frustum of a cone at the upper end of the reactor. The additional volume can be compensated or even overcompensated by reducing the length of the cylindrical reactor portion having the large diameter. The radius of the neck/the base radius of the frustum of a cone is configured such that no significant recirculation can occur in this upper reactor portion.

Although the flame already begins in the neck-like portion of the reactor, the heat flow towards the wall resulting therefrom does not result in high wall temperatures since the walls in this portion of the reactor are effectively cooled by the input stream flowing at high velocity and thus are preheated per se.

A second aspect of the invention is characterized in that the inlet region is cylindrical and the length ratio L1 to Dh (L1/Dh) is between 10 and 100, preferably between 15 and 30, or corresponds to these values. CFD simulation calculations show that this reduces the size of the recirculation zone of the gas flow formed in the main reactor portion and increases the achieved conversion to synthesis gas products.

A third aspect of the invention is characterized in that the inlet region is cylindrical and the length ratio D2 to D1 (D2/D1) is between 2 and 6, preferably between 3 and 5, or corresponds to these values. CFD simulation calculations show that this reduces the size of the recirculation zone of the gas flow formed in the main reactor portion and increases the achieved conversion to synthesis gas products.

A fourth aspect of the invention is characterized in that the inlet region is frustoconical and the opening angle of the frustum of the cone relative to the longitudinal axis of the partial oxidation reactor is between 1° and 30°, preferably between 5° and 20°, or corresponds to these values. CFD simulation calculations show that this reduces the size of the recirculation zone of the gas flow formed in the main reactor portion and increases the achieved conversion to synthesis gas products.

A fifth aspect of the invention is characterized in that the inlet region is frustoconical and the length ratio L1 to Dh (L1/Dh) is between 10 and 100, preferably between 15 and 30, or corresponds to these values. CFD simulation calculations show that this reduces the size of the recirculation zone of the gas flow formed in the main reactor portion and increases the achieved conversion to synthesis gas products.

A sixth aspect of the invention is characterized in that the inlet region is frustoconical and the length ratio D2 to D1 (D2/D1) is between 2 and 6, preferably between 3 and 5, or corresponds to these values. CFD simulation calculations show that this reduces the size of the recirculation zone of the gas flow formed in the main reactor portion and increases the achieved conversion to synthesis gas products.

A seventh aspect of the invention is characterized in that the burner opening does not project into the inlet region but rather terminates flush with the refractory lining of the inlet region. This reduces the thermal stress on the burner and its constituents and increases its service life.

An eighth aspect of the invention is characterized in that no means whatsoever for passing a fluid coolant through the partial oxidation burner are present. This aspect is especially relevant in conjunction with the seventh aspect of the invention since in this case the burner opening does not project into the inlet region, thus reducing the thermal stress on the burner and its constituents. Passing a fluid coolant through the partial oxidation burner can therefore be dispensed with. This reduces the susceptibility of the partial oxidation reactor to outages since shutdown of the plant upon the coolant outage is no longer applicable. In the context of the present invention a fluid coolant is to be understood here as meaning a fluid stream distinct from the input stream, the oxidant stream or an optional moderator stream.

A ninth aspect of the invention is characterized in that the feed channels of the partial oxidation burner terminate in a common plane which runs perpendicularly to the longitudinal axis of the burner and thus forms the burner opening. This aspect is especially also relevant in conjunction with the seventh and/or eighth aspect of the invention since in this case the burner opening does not project into the inlet region, thus reducing the thermal stress on the burner and its constituents. Passing a fluid coolant through the partial oxidation burner can therefore be dispensed with. This reduces the susceptibility of the partial oxidation reactor to outages since shutdown of the plant upon the coolant outage is no longer applicable.

An eleventh aspect of the invention is characterized in that in at least one of the further conditioning or processing steps carbon dioxide is separated from the raw synthesis gas and at least partially recycled to the partial oxidation burner as moderator. This makes it possible to improve the material utilization of carbon dioxide and reduce its emission as climate-damaging gas.

### BRIEF DESCRIPTION OF THE DRAWINGS

Developments, advantages and possible applications of the invention are also apparent from the following description of exemplary embodiments and the drawing. The invention is formed by all of the features described and/or depicted, either on their own or in any combination, irrespective of the way they are combined in the claims or the dependency references therein.

In the figures:

FIG. 1 shows a schematic representation of the cross section through the cylindrical main reactor portion of a partial oxidation reactor according to the prior art;

FIG. 2 shows a schematic representation of the cross section through the cylindrical main reactor portion of a partial oxidation reactor according to the invention having a cylindrical inlet region;

FIG. 3 shows a schematic representation of the cross section through the cylindrical main reactor portion of a partial oxidation reactor according to the invention having a frustoconical inlet region;

FIG. 4 shows a bar chart of the calculated residence time distribution for a partial oxidation reactor according to the prior art;

FIG. 5 shows a bar chart of the calculated residence time distribution for a partial oxidation reactor according to the invention.

### DETAILED DESCRIPTION OF THE PREFERRED EMBODIMENTS

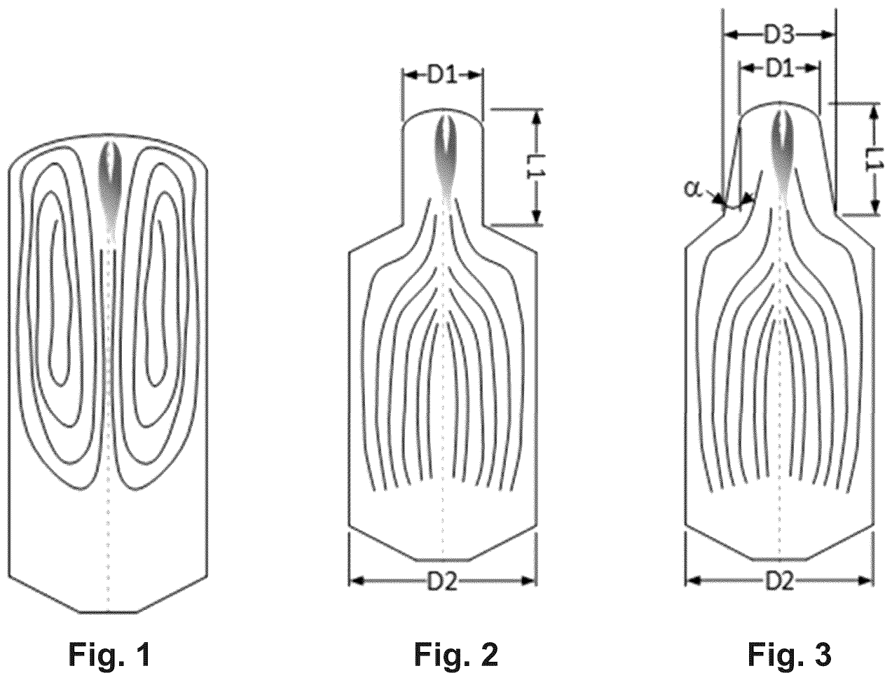

FIG. 1 shows a schematic representation of the cross section through the cylindrical main reactor portion of a partial oxidation reactor according to the prior art. The position of the burner at the upper reactor dome is indicated by a flame. A cross section through the recirculation zone, indicated by way of flow lines, is also shown. By contrast, the pronounced central gas flow from the entrance (burner) to the exit of the main reactor portion characteristic for this partial oxidation reactor according to the prior art is not shown.

FIG. 2 shows a schematic representation of the cross section through a partial oxidation reactor according to the invention having a cylindrical inlet region. Here, too the position of the burner is indicated by a flame. The figure in turn shows a cross section through the recirculation zone, indicated by way of flow lines, which is markedly reduced in size relative to a partial oxidation reactor according to the prior art.

FIG. 3 shows a schematic representation of the cross section through a partial oxidation reactor according to the invention having a frustoconical inlet region. Here, too the position of the burner is indicated by a flame. The figure in turn shows a cross section through the recirculation zone, indicated by way of flow lines, which in this exemplary embodiment of the invention too is markedly reduced in size relative to a partial oxidation reactor according to the prior art.

### Numerical Examples

To elucidate the advantages of the partial oxidation reactor design according to the invention the computer program Ansys Fluent was used to perform CFD simulations for the partial oxidation of natural gas, wherein the new reactor design was compared to a conventional reactor design.

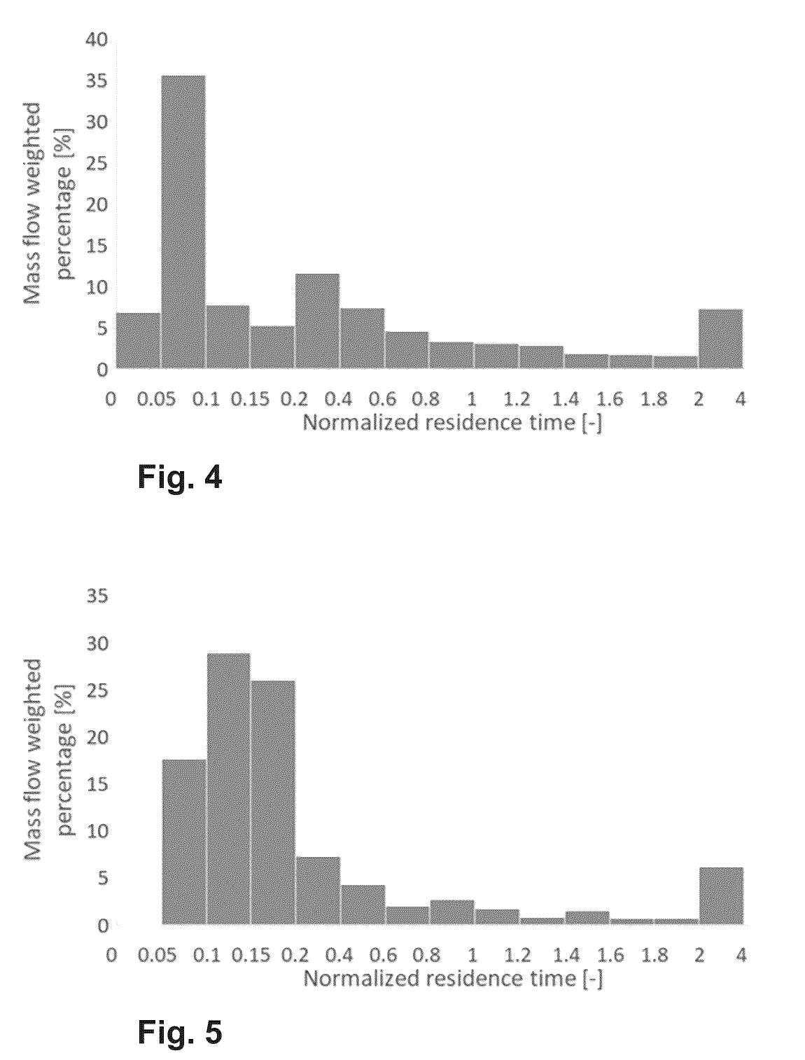

As a result of the CFD simulations FIG. 4 shows a bar chart of the calculated residence time distribution (normalized residence time distribution based on the respective average hydrodynamic residence time) for a partial oxidation reactor according to the prior art. It is clearly apparent that a first maximum exists at short residence times between 0.05 and 0.1 corresponding to the central gas flow from the entrance (burner) to the exit of the main reactor portion. There is moreover a broad distribution of values between 0.2 and 2 with a second pronounced maximum between 0.2 and 0.4. This is attributable to the existence of the recirculation zone which leads to the broad distribution of values for the residence times.

As a result of the CFD simulations FIG. 5 shows a bar chart of the calculated residence time distribution (normalized residence time distribution based on the respective average hydrodynamic residence time) for a partial oxidation reactor according to the invention having a cylindrical inlet region. The residence time distribution for the partial oxidation reactor according to the invention is altogether narrower; the range between 0.05 and 0.2 is most pronounced. Shorter residence times are not present. The distribution of values between 0.2 and 2 is less pronounced than in the partial oxidation reactor according to the prior art. A second maximum exists at longer residence times between 0.8 and 1 and is markedly less pronounced than in FIG. 4. This is attributable to the markedly weaker recirculation zone in the partial oxidation reactor according to the invention.

Changes to the above-described embodiments of the present disclosure are possible without departing from the scope of the present disclosure defined by the accompanying claims. Expressions such as “including”, “comprising”, “containing”, “have”, “is” which are used for describing and claiming the present disclosure shall be understood in a nonexhaustive manner, i.e. they also allow for the presence of articles, components or elements that are not explicitly described. References to the singular are to be understood as also referring to the plural in the absence of explicit indications to the contrary in the particular case.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A partial oxidation reactor for producing a raw synthesis gas stream by partial oxidation of a carbon-containing input stream in gaseous form, in liquid form or in solid, particulate form dispersed in a carrier liquid or a carrier gas in the presence of an oxygen-containing oxidant stream and a moderator stream containing steam and/or carbon dioxide comprising the following constituents and/or assemblies in fluid connection with one another:
(a) a cylindrical or frustoconical inlet region comprising a pressure-bearing, gas-impermeable first outer wall whose interior is lined with a refractory lining, wherein
(a1) the cylindrical inlet region has a length L1 and at an entrance and at an exit has a free internal diameter D1 or
(a2) the frustoconical inlet region has a length L1 and at an entrance has a free internal diameter D1 and at an exit has a free internal diameter D3;
(b) a cylindrical main reactor portion comprising a pressure-bearing, gas-impermeable second outer wall whose interior is lined with a refractory lining, wherein the cylindrical main reactor portion has a length L2 and a free internal diameter D2, wherein L2 is greater than L1 and wherein D2 is greater than D1 and D3;
(c) a frustoconical or dome-shaped transition region arranged between and gastightly connecting the inlet region and the main reactor portion comprising a pressure-bearing, gas-impermeable third outer wall whose interior is lined with a refractory lining, wherein the frustoconical or dome-shaped transition region has a length L3 and at an entrance-side end has a free internal diameter D1 or D3 and at an exit-side end has a free internal diameter D2, wherein L3 is smaller than L1;
(d) a partial oxidation burner (POX burner) gastightly connected to the inlet region, wherein the partial oxidation burner comprising the following constituents:
(d1) a central first feed channel having a circular cross section,
(d2) a further second feed channel coaxially and concentrically surrounding the first feed channel as an annular gap between the outer wall of the first feed channel and the inner wall of the second feed channel,
(d3) a further third feed channel coaxially and concentrically surrounding the second feed channel as an annular gap between the outer wall of the second feed channel and the inner wall of the third feed channel,
(d4) a means for separately supplying the carbon-containing input stream, the oxygen-containing oxidant stream and the moderator stream to the first, second and third feed channel, wherein the feed channel for the oxygen-containing oxidant stream has a hydraulic diameter Dh;
(e) a product outlet for the raw synthesis gas stream which is gastightly connected to the main reactor portion;
(f) a means for introducing the input stream, the oxidant stream and the at least one moderator stream to the partial oxidation burner;
(g) a means for discharging the raw synthesis gas stream from the partial oxidation reactor via the product outlet.

2. The partial oxidation reactor according to claim 1, wherein the inlet region is cylindrical and the length ratio L1 to Dh (L1/Dh) is between 10 and 100 or corresponds to these values.

3. The partial oxidation reactor according to claim 1, wherein the inlet region is cylindrical and the length ratio D2 to D1 (D2/D1) is between 2 and 6 or corresponds to these values.

4. The partial oxidation reactor according to claim 1, wherein the inlet region is frustoconical and the opening angle of the frustum of the cone relative to the longitudinal axis of the partial oxidation reactor is between 1° and 30° or corresponds to these values.

5. The partial oxidation reactor according to claim 4, wherein the inlet region is frustoconical and the length ratio L1 to Dh (L1/Dh) is between 10 and 100 or corresponds to these values.

6. The partial oxidation reactor according to claim 4, wherein the inlet region is frustoconical and the length ratio D2 to D1 (D2/D1) is between 2 and 6 or corresponds to these values.

7. The partial oxidation reactor according to claim 1, wherein the burner opening does not project into the inlet region but rather terminates flush with the refractory lining of the inlet region.

8. The partial oxidation reactor according to claim 7, wherein no means whatsoever for passing a fluid coolant through the partial oxidation burner are present.

9. The partial oxidation reactor according to claim 1, wherein the feed channels of the partial oxidation burner terminate in a common plane which runs perpendicularly to the longitudinal axis of the burner and thus forms the burner opening.

10. A process for producing a raw synthesis gas stream by partial oxidation of a carbon-containing input stream in gaseous form, in liquid form or in solid, particulate form dispersed in a carrier liquid or a carrier gas in the presence of an oxygen-containing oxidant stream and at least one moderator stream containing steam and/or carbon dioxide comprising the following steps:
(a) providing a partial oxidation reactor according to claim 1;
(b) providing the carbon-containing input stream, the oxygen-containing oxidant stream and the at least one moderator stream;
(c) introducing the carbon-containing input stream, the oxygen-containing oxidant stream and the at least one moderator stream into the partial oxidation reactor via the partial oxidation burner;
(d) reacting the carbon-containing input stream with the oxygen-containing oxidant stream in the partial oxidation reactor under conditions of non-catalytic partial oxidation;
(e) discharging the raw synthesis gas stream from the partial oxidation reactor via the product outlet;
(f) supplying the raw synthesis gas stream to further purification, conditioning or processing steps.

11. The process according to claim 10, wherein in at least one of the further conditioning or processing steps carbon dioxide is separated from the raw synthesis gas and at least partially recycled to the partial oxidation burner as moderator.
